(19) United States
(12) Patent Application Publication
(10) Pub. No.: US 2008/0077664 A1
(43) Pub. Date: Mar. 27, 2008

(54) METHOD AND APPARATUS FOR DISTRIBUTING MESSAGES IN A COMMUNICATION NETWORK

(75) Inventors: KABE VANDERBAAN, CHICAGO, IL (US); JEFFREY T. ESCHBACH, HOFFMAN ESTATES, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/421,227

(22) Filed: May 31, 2006

(51) Int. Cl. G06F 15/16

(52) U.S. Cl. 709/204

(57) ABSTRACT

A method for distributing messages in a communication network is provided. The method includes obtaining a text message from a source device in the communication network. The method also includes translating the text message to generate an audio message. Moreover, the method includes associating the text message with the audio message, to provide an association between the text message and the audio message. Further, the method includes sending the audio message to a plurality of target devices in the communication network.

### CROSS-REFERENCE TO RELATED APPLICATIONS

The present application is related to the following U.S. application commonly owned together with this application by Motorola, Inc.:

Ser. No. 11/094646, filed Mar. 30, 2005, titled “Methods And Apparatus For Providing Push To Talk Text Data” by Vanderbaan, et al. (attorney docket no. CML02010N).

### FIELD OF THE INVENTION

The present invention relates generally to the field of communication networks. More particularly, the present invention relates to distribution of messages in communication networks.

### BACKGROUND OF THE INVENTION

Communication networks include a plurality of communication devices that communicate among themselves. Examples of a communication network include a push-to-talk (PTT) communication network, the Internet, a dispatch network, and so forth. The plurality of communication devices communicate among themselves by exchanging data such as voice data, text data and/or multimedia data. Examples of a communication device include a mobile phone, a computer, a Personal Digital Assistant (PDA), a laptop, and so forth.

Text messages have become a common medium of communication. For example, in a public safety environment, such as in rescue operations, a text message may be sent to a specific group of first responders from a central command center. However, one or more of the first responders that received the text message may not be able to immediately view the text message if he or she is preoccupied or has to focus visually on an event.

This issue of a user being too preoccupied to read a text message can be addressed using some known methods. In one such method, people at the command center transmit the audio output of a text message by reading the text message. In another such method, audio messages, instead of text messages, are transmitted to the target communication device. However, these methods suffer from one or more of the following limitations. First, if individually translated, the messages may not be sent to multiple communication devices at the same time. This causes delay in distribution of the messages. Second, implementation of the methods can be tiresome due to involvement of human effort. Third, these methods may not provide the facility of retrieving and playing back the audio message in future.

Therefore, there exists a need for a method and system to audibly distribute the contents of a text message to users, some of whom may not be able to immediately read the text message themselves. It is further desirable that the method and system ensure near real-time distribution of the contents of the text message, eliminate human intervention, enable distribution of the contents of the message to multiple target devices at the same time, and provide the facility of retrieving and playing back in the future a translated audio message associated with the text message.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages ail in accordance with the present invention,

FIG. 1 illustrates a communication network, in accordance with an embodiment of the present invention;

FIG. 2 illustrates a communication network, in accordance with another embodiment of the present invention;

FIG. 3 illustrates a block diagram of an apparatus for distributing messages in a communication network, in accordance with an embodiment of the present invention;

FIG. 4 is a flow diagram illustrating a method for distributing messages in a communication network, in accordance with an embodiment of the present invention; and

FIG. 5 is a flow diagram illustrating a method for distributing messages in a communication network, in accordance with another embodiment of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for distributing messages in a communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for distributing messages in a communication network described herein. The non-processor circuits may include, but are not limited to, a radio receiver, a radio transmitter and user input devices. As such, these functions may be interpreted as steps of a method to perform the distributing of messages in a communication network described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, the present invention describes a method for distributing messages in a communication network. The method involves obtaining a text message from a source device in the communication network. The text message is then translated to a corresponding audio message that is referred to herein as a translated audio message. The method also involves associating the text message with the translated audio message. Moreover, the method involves sending the translated audio message to a plurality of target devices in the communication network.

The present invention also describes an apparatus for distributing messages in a communication network. The apparatus includes a processing device that translates a text message to a corresponding audio message that is referred to herein as a translated audio message, and associates the text message with the translated audio message. The apparatus also includes a transmitter that is coupled to the processing device. The transmitter sends the translated audio message to a plurality of target devices in the communication network.

Various embodiments of the present invention allow users to receive information in messages without causing distraction. This is especially useful for users operating in a public safety environment, such as for the users involved in rescue operations. The invention also enables distribution of messages to multiple target devices at the same time. Further, the invention minimizes human intervention, thereby avoiding delay and saving considerable time. Moreover, the invention facilitates the retrieval of both text messages and associated translated audio messages for future playback. Those skilled in the art will realize that the above recognized advantages and other advantages described herein are merely exemplary and are not meant to be a complete rendering of all of the advantages of the various embodiments of the present invention.

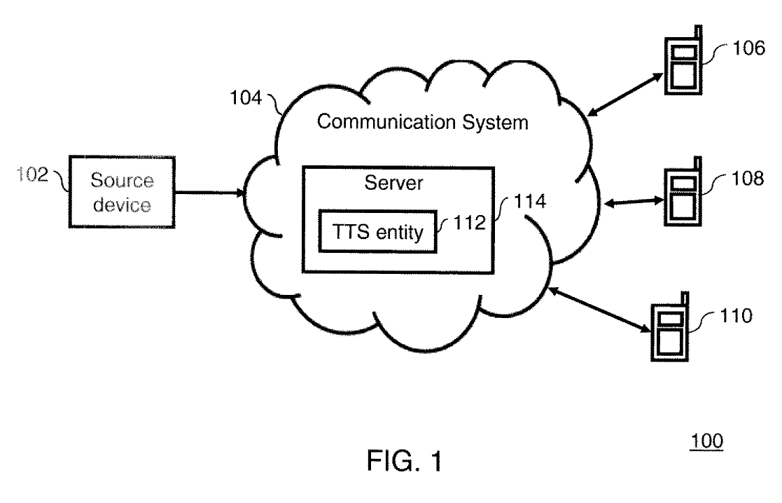

Referring now to the drawings, and in particular FIG. 1, for purposes of providing an illustrative but non-exhaustive example to facilitate this description, a specific operational paradigm using a communication network is shown and indicated generally as communication network 100. Those skilled in the art, will, however, recognize and appreciate that the specifics of this illustrative example are not the specifics of the invention itself, and that the teachings set forth herein are applicable in a variety of alternative settings. For example, since the teachings described do not depend on any particular platform, they can be applied to any type of system, such as, but not limited to, Code Division Multiple Access (CDMA) systems, Time Division Multiple Access (TDMA) systems, Universal Mobile Telecommunications Systems (UMTSs), General Packet Radio Service (GPRS) systems, Internet Protocol-based systems, and non-cellular network systems. As such, other alternative implementations using different types of communication networks that include the feature of distribution of messages are contemplated and are within the scope of the various teachings described.

Referring now to the exemplary communication network 100, shown in FIG. 1, the communication network 100 includes a source device 102, a communication system 104, and a plurality of target devices (only three of which are shown for illustrative purposes although typically the network 100 will comprise many more such devices). Examples of the communication network 100 include a push-to-talk (PTT) communication network, the Internet, a dispatch network, and so forth. The source device 102 transmits messages (such as a text message) to the plurality of target devices such as a target device 106, a target device 108, and a target device 110. For example, in a public safety system, such as in rescue operations, a message can be transmitted to a group of first responders from a central command center. These messages are transmitted through the communication system 104. The communication system 104 can be the infrastructure that enables the transmission of the messages to the plurality of target devices.

The communication system 104 can include servers, Base Transceiver Stations (BTSs), Base Station Controllers (BSCs), and so forth. The messages can be sent to the plurality of target devices through various communication channels and using various protocols. In an embodiment of the present invention, text messages can be sent by using any suitable reliable protocol including, but not limited to, Transmission Control Protocol (TCP). The audio messages can be sent to the plurality of target devices in near real-time by using any suitable unreliable protocol including, but not limited to, User Datagram Protocol (UDP). Examples of a source device and/or a target device can include a mobile phone, a computer, a laptop, and a PDA.

The communication system 104 further includes a Text-To-Speech (TTS) entity 112 in a server 114, which is configured in accordance with embodiments described herein. The server 114 facilitates the communication of messages between the source device 102 and the plurality of target devices comprising network 100. The TTS entity 112 is configured to translate a text message to generate a corresponding audio message that is referred to herein as a translated audio message.

Referring to FIG, 2, a communication network 200 is shown, according to another embodiment of the present invention. The communication network 200 includes a source device 102, a communication system 104, and a plurality of target devices. The source device 102 transmits messages to the plurality of target devices such as a target device 106, a target device 108, and a target device 110. The source device 102 is configured in accordance with embodiments described herein and includes the TTS entity 112. The TTS entity 112 is configured to translate a text message to generate a corresponding audio message that is referred to herein as a translated audio message. The source device can send the translated audio message to the plurality of target devices through the communication system 104. The communication system 104 further includes the server 114, which facilitates the communication of messages between the source device 102 and the plurality of target devices comprising network 200.

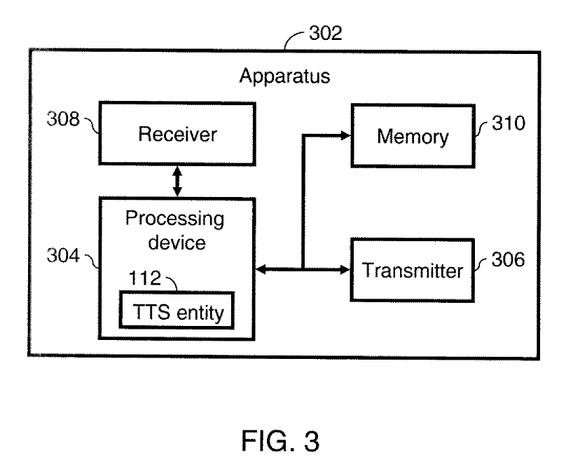

Referring to FIG. 3, an apparatus 302 for distributing messages in the communication networks 100 and 200 is shown, according to various embodiments of the invention. The apparatus or portions thereof can comprise, for instance, the source device 102, the server 114 and the target devices (since those of ordinary skill in the art will recognize that the target devices may also function as source devices). The source device, server and target device can be included in a push-to-talk network. A push-to-talk network is one that includes devices (such as subscriber units) that have a push-to-talk feature, as is well known in the art.

The apparatus 302 includes a processing device 304 and a transmitter 306. The apparatus 302 further includes a receiver 308 and a memory 310. The receiver, transmitter and memory can be any such suitable elements as are well known in the art and which will not, therefore, be further described herein for the sake of brevity. The processing device 304 can be implemented, for example, in accordance with one or more embodiments of a processing device as described above. The receiver, processing device, memory and transmitter are all operatively coupled together in accordance with well known coupling methods. For example, these elements may be included on a single integrated circuit chip.

The processing device can translate a text message to a translated audio message in accordance with the teachings herein. In an embodiment of the present invention, the processing device 304 includes the TTS entity 112, which is a logical entity that represents the functionality performed by the processing device 304 of translating a text message to generate a corresponding audio message. The TTS entity 112 can be present at one or more of a source device and a server external to the source device. The processing device 304 can further associate the text message and the translated audio message to provide an association between them. In an embodiment of the present invention, the association can be based on an identifier associated with the text message as well as the translated audio message. For example, a particular sequence of numbers can be inserted in the metadata of the text message and the translated audio message as an identifier.

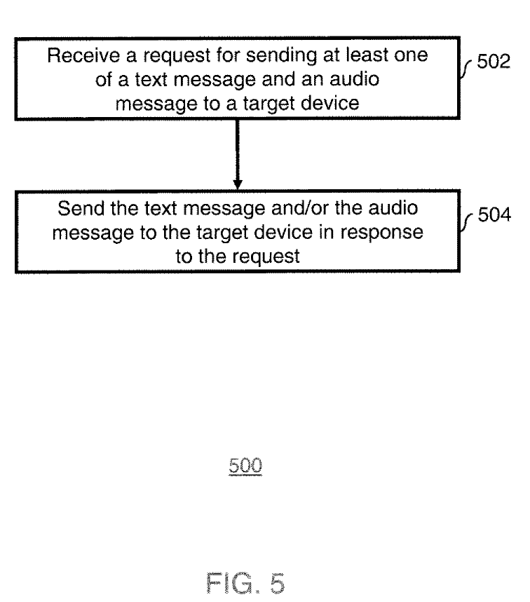

Thereafter, the transmitter 306 sends the translated audio message and/or the text message to the target device 106, the target device 108, and/or the target device 110. In an embodiment of the present invention, the translated audio message is also sent to the source device 102. This may be useful, for example, so the user of the source device 102 can confirm that the actual content of the text message is sent in the audio message. Typically, the transmitter 306 sends the text message and the translated audio message over separate communication channels. This ensures that the text message is reliably distributed and the audio message is distributed in near real-time. In an embodiment of the present invention, the text message is sent by using a reliable protocol such as TCP, and the audio message is sent using an unreliable protocol such as UDP. The receiver 308 can obtain the text message from the source device 102 in one embodiment, and in another embodiment the text message can be “obtained” by the source device generating the text message. Moreover, at least one of the text message and the translated audio message is optionally (and desirably) stored in the memory 310 in the apparatus 302 to facilitate implementation of the teachings herein, especially with respect to a retrieval and playback feature or embodiment described in more detail below with respect to FIG. 5.

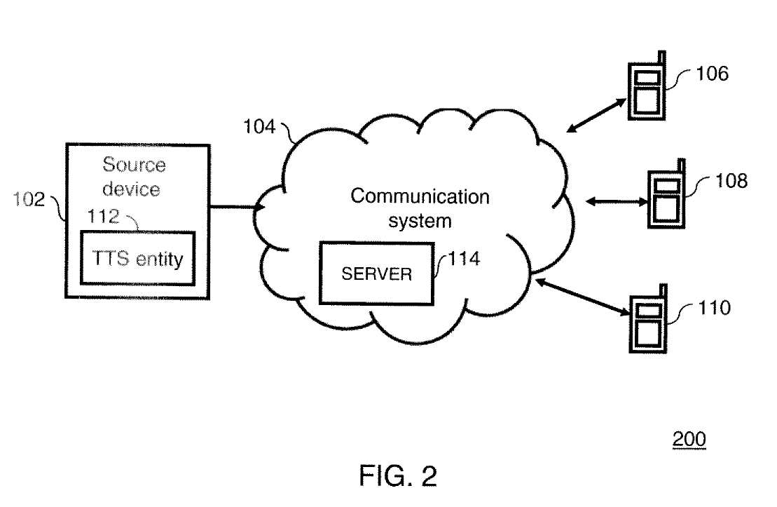

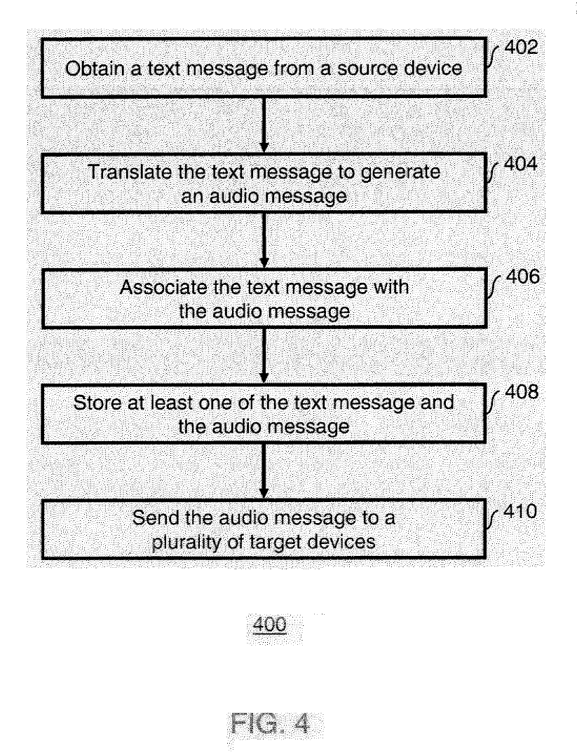

Turning now to FIG. 4, a flow diagram illustrating a method 400 for distributing messages in the communication network 100 is shown, according to an embodiment of the invention. To describe the method, reference will be made to FIG. 1, FIG. 2 and FIG. 3, although it is understood that the method can also be implemented with reference to any other suitable network and apparatus embodiment of the present invention.

In accordance with a first implementation (as illustrated by reference to FIG. 1) all or a portion of the steps of method 400 are performed in the server 114 of communication system 104 using at least a portion of apparatus 302. At step 402, a text message is obtained by the server 114 from the source device 102 via the receiver 308 of apparatus 302. The text message is generated by the source device 102 using, for example, any suitable application running on the source device. At step 404, the TTS entity 112 in the server 114 translates the text message to generate a corresponding audio message also referred to herein as a translated audio message. The processing device 304 in the server associates the text message with the translated audio message at step 406. This association can be based on an identifier associated with both the text message and the translated audio message. The server 114 stores the text message and/or the translated audio message (usually both) and the identifier associating them in memory 310, at step 408. This is useful for the server to implement the retrieval method illustrated by reference to FIG. 5. However, it should be realized by those skilled in the art that the text and/or translated audio message can in addition to (or alternatively) be stored in the source device for implementing the retrieval method.

At step 410 and using transmitter 306, the server 114 transmits the translated audio message to one or more of the plurality of target devices in the communication network using an unreliable protocol such UDP. For example, in a public safety implementation, two or more of the target devices may comprise a given talk group and the source device may be the command center or another device in the talk group that desires to audibly transmit at least the contents of a text message to the target devices. The source device can, in accordance with the teachings herein, transmits the text message to the server 114 (e.g., at a dispatch center) in system 104, and the server translates the text message to a corresponding audio message, associates the text message with translated audio message based on an identifier, stores the text message, optionally the translated audio message and the identifier, and transmits the audio message to the talk group. Usually, the translated audio message is not sent to the source device, but as described above can be sent to the source device in an alternative implementation. In a further implementation, the server also sends the text message to the target devices in the talk group and optionally to the source device.

In accordance with a second implementation (as illustrated by reference to FIG. 2) all or a portion of the steps of method 400 are performed in the source device 102 using at least a portion of apparatus 302. At step 402, a text message is obtained by the source device 102 generating the text message using the processing device 304 of apparatus 302. At step 404, the TTS entity 112 in the source device 102 translates the text message to generate a corresponding audio message also referred to herein as a translated audio message. The processing device 304 in the source device associates the text message with the translated audio message at step 406. Just as in the first implementation described above, the server 114 can store the text message and/or the translated audio message and the identifier associating them in memory 310, at step 408. However, the text and/or translated audio message can in addition to (or alternatively) be stored in the source device 102.

At step 410 and using transmitter 306, the source device transmits the translated audio message to one or more of the plurality of target devices in the communication network. This transmission can be via the server 114, for example, so that the server can store information as described above. In a further implementation, the source device or the server sends the text message to the target devices in the talk group and optionally to the source device.

Turning now to FIG. 5, a flow diagram illustrating a retrieval method 500 for implementation in the communication networks 100 and 200 is shown. according to one embodiment of the invention. To describe the method, reference will be made to FIG. 1, FIG. 2 and FIG. 3, although it is understood that the method can also be implemented with reference to any other suitable embodiment of the present invention. Moreover, it should be noted that the steps described in FIG. 5 can also be performed in conjunction with steps described in FIG. 4. In one embodiment, the server 114 performs steps included in method 500, and in another embodiment the source device can perform all or a portion of these steps.

At step 502, a request is received for sending at least one of a text message and a translated audio message. In an embodiment of the present invention, the request is received by the receiver 308 in the apparatus 302. In an embodiment of the present invention, the request can include an identifier, which in another embodiment can comprise the text message or a portion thereof.

Thereafter, in an embodiment of the present invention, the text message is translated to the translated audio message. The text message is first retrieved from the memory 310, based on an identifier in the request, and then it can be translated to generate the translated audio message. In an embodiment of the present invention, the processing device 304 can retrieve a text message from the memory 310. Further, the text message can be translated by the TTS entity 112 in the processing device 304. The text message and the translated audio message can be processed by the TTS entity 112, The TTS entity 112 can be present at the source device 102, a target device in the communication network 100, and/or a server that is external to both the source device 102 and the target device.

In another embodiment of the present invention, the translated audio message can be retrieved from the memory 310, based on an identifier in the request. In an embodiment of the present invention, the processing device 304 can retrieve a text message and/or a translated audio message from the memory 310.

At step 504, the text message and/or the translated audio message is sent to the target device, in response to the request made by the target device. In an embodiment of the present, invention, the text message and/or the translated audio message are sent by the transmitter 306 to the target device. The target device can use the translated audio message for playback.

As described above, various embodiments of the present invention enables augmentation of a text message distributed to a group of target devices with an automatically generated translated audio message. This mechanism enables easier and seamless transition of messages to the target devices amidst congested environments in a communication network by enabling the text message sent to the group of target devices to be also received audibly. The use of a translated audio message in the present invention provides a user-friendly method to receive information that is not visually disruptive, while allowing the associated text message to be distributed as well. The present invention also facilitates the retrieval of both the text message and the associated translated audio message by the target devices for future playback.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about”, “near” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for distributing messages in a communication network, comprising the steps of:
obtaining a text message from a source device in the communication network;
translating the text message to generate an audio message;
associating the text message with the audio message to provide an association between the text message and the audit) message; and
sending the audio message to a plurality of target devices in the communication network.

2. The method as recited claim 1 further comprising the step of sending the text message to the source device and at least a portion of the plurality of target devices that received the audio message.

3. The method as recited in claim 1, wherein the text message is sent using a reliable protocol.

4. The method as recited in claim 3, wherein the text message is sent using Transmission Control Protocol (TCP).

5. The method as recited in claim 1, wherein the association between the text message and the audio message is based on an identifier associated with both the text message and the audio message,

6. The method as recited in claim 1 further comprising the step of storing at least one of the text message and the audio message.

7. The method as recited in claim 1 further comprising the step of receiving a request for sending at least one of the text message and the audio message to a target device of the plurality of target devices.

8. The method as recited in claim 7 further comprising sending the at least one of the text message and the audio message to the target device in response to the request, using the association between the text message and the audio message.

9. The method as recited in claim 1, wherein the audio message is sent using an unreliable protocol.

10. The method as recited in claim 9, wherein the unreliable protocol is User Datagram Protocol (UDP).

11. The method as recited in claim 1, wherein the method is performed in one of the source device and a server external to the source device in the communication network.

12. An apparatus for distributing messages in a communication network comprising:
a processing device,
translating a text message to generate an audio message; and
associating the text message with the audio message to provide an association between the text message and the audio message; and
a transmitter coupled to the processing device and sending the audio message to a plurality of target devices in the communication network.

13. The apparatus as recited in claim 12 further comprising a receiver coupled to the processing device and obtaining the text message from a source device in the communication network.

14. The apparatus as recited in claim 12 further comprising a memory coupled to the processing device and storing at least one of the text message and the audio message.

15. The apparatus as recited in claim 12, wherein the transmitter further sends the text message to at least a portion of the plurality of target devices that received the audio message.

16. The apparatus as recited in claim 12, wherein the apparatus resides on one of a source device and a server external to the source device in the communication network.

17. The apparatus as recited in claim 12, wherein the apparatus is included in a push-to-talk communication network.
